(19) United States
(12) Patent Application Publication
(10) Pub. No.: US 2008/0131831 A1
(43) Pub. Date: Jun. 5, 2008

(54) DUAL CYLINDRICAL ARCH WIRE ASSEMBLY FOR APPLYING TORQUE

(76) Inventors: Norbert Abels, Homburg (DE); Claus H. Backes, Saarbrucken (DE)

Correspondence Address: WORKMAN NYDEGGER, 60 EAST SOUTH TEMPLE, 1000 EAGLE GATE TOWER, SALT LAKE CITY, UT, 84111, US

(21) Appl. No.: 11/565,269

(22) Filed: Nov. 30, 2006

(51) Int. Cl. A61C 3/00

(52) U.S. Cl. 433/10; 433/24

(57) ABSTRACT

An arch wire assembly for use in light force orthodontic treatment techniques which includes the ability to provide a torquing force to selected teeth. The arch wire assembly includes an arch wire comprising first and second cylindrical arch wire bodies extending between a first end and a second end. The arch wire bodies are disposed in adjacent contact one with another. The arch wire assembly further includes clamping or other fixing structures for fixing the first and second arch wire bodies relative to one another so as to allow the first and second cylindrical arch wire bodies to act as a single arch wire having a non circular cross-sections. This allows for application of torquing corrective forces against an arch wire slot of an orthodontic bracket during an orthodontic treatment in much the same way as a rectangular arch wire but with lower arch wire stiffness. This allows for light force orthodontic treatment.

### BACKGROUND OF THE INVENTION

1. The Field of the Invention

The present invention relates to arch wires for use with orthodontic brackets in correcting spacing and orientation of the teeth.

2. The Relevant Technology

Orthodontics is a specialized field of dentistry that involves the application of mechanical forces to urge poorly positioned, or crooked, teeth into correct alignment and orientation. Orthodontic procedures can be used for cosmetic enhancement of teeth, as well as medically necessary movement of teeth to correct overjets or overbites. For example, orthodontic treatment can improve the patient's occlusion, or enhanced spatial matching of corresponding teeth.

The most common form of orthodontic treatment involves the use of orthodontic brackets and wires, which together are commonly referred to as “braces.” Orthodontic brackets, more particularly the orthodontic bases, are small slotted bodies configured for direct attachment to the patient's teeth or, alternatively, for attachment to bands which are, in turn, cemented or otherwise secured around the teeth. Once the brackets are affixed to the patient's teeth, such as by means of glue or cement, a curved arch wire is inserted into the slot of each bracket. The arch wire acts as a template or track to guide movement of the teeth into proper alignment.

There are two distinct classes of orthodontic brackets: those that require the use of ligatures to fasten the arch wire to the bracket, and those that are self-ligating. In brackets of the first class, small ligature wires are typically used to hold the arch wire in a securely seated position in the brackets. Ligatures or some other form of fastening means are essential to ensure that the tensioned arch wire is properly positioned around the dental arch, and to prevent the wire from being dislodged from the bracket slots during chewing of food, brushing of teeth, or application of other forces. One type of commercially available ligature is a small, elastomeric O-ring, which is installed by stretching the O-ring around small wings known as “tie wings” that are connected to the bracket body. Metal ligatures are also used to retain arch wires within the bracket slots.

In an effort to simplify the process of installing braces, a variety of self-ligating brackets have been developed. The term “self-ligating bracket” refers to a class of orthodontic brackets that include some sort of cover, whether separate from or hingedly or slidably attached to the base, which encloses or otherwise retains the arch wire within the slot of the base.

Arch wires typically have either a square, rectangular, or round cross-section. Square and rectangular cross-sections allow the arch wire to be used to apply a torquing force when engaged in an arch wire slot of an orthodontic bracket. Torquing forces provide for tooth movement in the labial and/or lingual directions. Although a wire having a round cross-section does not allow application of torquing forces when engaged within an arch wire slot, it does provide a greater degree of flexibility and generally requires less force to effect movement, which is more comfortable for the patient. As such, round wires are often useful during the beginning stages of orthodontic treatment when the teeth are most mal-aligned. Use of such a round arch wire allows for movement of teeth to correct spacing and alignment issues with relatively light (and more comfortable) forces. Once these corrections have been achieved, a square or rectangular wire typically replaces the round arch wire, so as to allow torquing of selected teeth to complete the treatment.

It would be an improvement in the art to provide an arch wire having a geometric configuration that would provide flexibility and low force correction like a round arch wire, while also being simultaneously capable of applying torquing forces to selected teeth. Such an arch wire would provide movement of teeth to correct spacing and alignment with light forces, while simultaneously providing torquing movements, which would provide for faster overall treatment times, while also providing increased comfortable for the patient during torquing correction. It would be a further improvement if such an arch wire could be easily and inexpensively manufactured.

### BRIEF SUMMARY OF THE PREFERRED EMBODIMENTS

The present invention is directed to an arch wire assembly suitable for use in a low force orthodontic treatment technique which includes the ability to provide a torquing force to selected teeth while simultaneously applying forces to correct spacing and alignment issues. In other words, the inventive arch wire assembly advantageously provides the benefits of both round and rectangular cross-section wires within a single arch wire. The arch wire assembly includes an arch wire comprising first and second cylindrical arch wire bodies extending between a first end and a second end. The arch wire bodies are disposed in adjacent contact with one another. The arch wire assembly further includes means for fixing the first and second arch wire bodies relative to one another so as to allow the first and second cylindrical arch wire bodies to act as a single arch wire having a cross-section that allows for application of torquing corrective forces against an arch wire slot of an orthodontic bracket during an orthodontic treatment. Advantageously, the inventive arch wire assembly is able to provide low force correction similar to a round arch wire, while also being capable of providing torquing correction, similar to a rectangular arch wire.

In one example, a plurality of crimpable clamps are included with the arch wire for fixing the first and second arch wire bodies relative to one another. The crimpable clamps may be configured to enclose around the perimeter of the whole arch wire (i.e., the first and second arch wire bodies). Initially, the clamps may be freely slidable along the length of the arch wire so as to be slidable to any desired position for crimping. Once crimped (e.g., with pliers), each of the first and second arch wire bodies are held together so as to prevent rotation of one arch wire body about its longitudinal axis relative to the other arch wire body. In other words, once clamped together, the two arch wire bodies act as a single arch wire having an approximate “figure 8” cross-section, which allows for application of a torquing force when the arch wire assembly is inserted into a slot of an orthodontic bracket. Advantageously, the arch wire also exhibits less stiffness and a lower moment of inertia than a similarly sized rectangular arch wire (e.g., having a width and length that is equal to the maximum width and maximum length of the dual cylindrical arch wire) so as to deliver correction with relatively low forces. That is because the arch wire assembly has a smaller cross-sectional area compared to a similarly-sized rectangular arch wire.

In an alternative embodiment, the first and second arch wire bodies may be fused together (e.g., by welding or gluing) so as to fix the first arch wire body relative to the second arch wire body. In such an embodiment, the fusing may be accomplished during manufacture.

Advantageously, such an arch wire assembly has a significantly reduced stiffness and moment of inertia relative to a rectangular arch wire of similar material and dimensions (i.e., having a length and width equal to the maximum length and maximum width of the dual cylindrical arch wire). The decreased stiffness and moment of inertia results from the unique cross-section of the arch wire, which includes a relatively small transverse cross-sectional area that is less than the cross-section of a rectangular arch wire having a similar width and length as described above. Decreased stiffness and moment of inertia allows for the orthodontic treatment to be accomplished with application of relatively light (and therefore more comfortable) forces.

In addition, the dual cylindrical arch wire having a unique cross-section so as to provide for torquing movements is easily and inexpensively manufactured, as it may be formed from two round wires, which shape is easily drawn during manufacture as contrasted with an exotic cross-sectional geometry that may otherwise be difficult and/or expensive to manufacture.

These and other advantages and features of the present invention will become more fully apparent from the following description and appended claims, or may be learned by the practice of the invention as set forth hereinafter.

### BRIEF DESCRIPTION OF THE DRAWINGS

To further clarify the above and other advantages and features of the present invention, a more particular description of the invention will be rendered by references to specific embodiments thereof, which are illustrated in the appended drawings. It is appreciated that these drawings depict only typical embodiments of the invention and are therefore not to be considered limiting of its scope. The invention will be described and explained with additional specificity and detail through the use of the accompanying drawings in which:

FIG. 1A is a perspective view of an exemplary dual cylindrical arch wire assembly;

FIG. 1B is a cross-sectional view of the arch wire assembly of FIG. 1A along lines 1B-1B;

FIG. 2 is a perspective view of a portion of the arch wire of FIG. 1A placed within a slot of an orthodontic bracket;

FIG. 3A is a cross-sectional view of an exemplary dual cylindrical arch wire including first and second arch wire bodies received within a slot of an orthodontic bracket;

FIG. 3B is a cross-sectional view of a rectangular arch wire received within a slot sized similarly to that of FIG. 3A;

FIG. 3C is a cross-sectional view of another rectangular arch wire received within a slot sized similarly to that of FIG. 3A;

FIG. 3D is a cross-sectional view of another exemplary dual cylindrical arch wire including first and second arch wire bodies received within a slot sized similarly to that of FIG. 3A;

FIG. 3E is a cross-sectional view of another exemplary dual cylindrical arch wire including first and second arch wire bodies received within a differently sized slot of an orthodontic bracket;

FIG. 3F is a cross-sectional view of another exemplary dual cylindrical arch wire including first and second arch wire bodies received within yet another differently sized slot of an orthodontic bracket;

FIG. 3G is a cross-sectional view of the exemplary dual cylindrical arch wire of FIG. 3F received within a somewhat wider slot of an orthodontic bracket;

FIG. 4A illustrates a plurality of teeth on each of which has been installed an orthodontic bracket;

FIG. 4B illustrates the inventive dual cylindrical torquing arch wire inserted within a slot of each orthodontic bracket;

FIG. 4C illustrates pliers being used to crimp one of the crimpable clamps so as to fix the first arch wire body relative to the second arch wire body;

FIG. 4D illustrates a bend having been applied to a portion of the arch wire, and then the pliers being used to crimp another of the crimpable clamps so as to fix the arch wire bodies and hold the bend in the arch wire; and

FIG. 4E illustrates the orthodontic brackets and dual cylindrical arch wire once all of the clamps have been crimped so as to fix the arch wire bodies relative to one another.

### DETAILED DESCRIPTION OF THE PREFERRED EMBODIMENTS

### I. Introduction

The invention generally relates to an arch wire assembly suitable for use in a light force orthodontic treatment technique, which includes the ability to provide a torquing force to selected teeth while simultaneously applying forces to correct spacing and alignment issues. The arch wire assembly includes an arch wire comprising first and second cylindrical arch wire bodies extending between a first end and a second end. The arch wire bodies are advantageously disposed in adjacent contact with one another. The arch wire assembly further includes means for fixing the first and second arch wire bodies relative to one another. This allows the first and second cylindrical arch wire bodies to act as a single arch wire having a unique cross-section that allows for application of torquing corrective forces against an arch wire slot of an orthodontic bracket during an orthodontic treatment.

### II. Exemplary Dual Cylindrical Arch Wire Assemblies

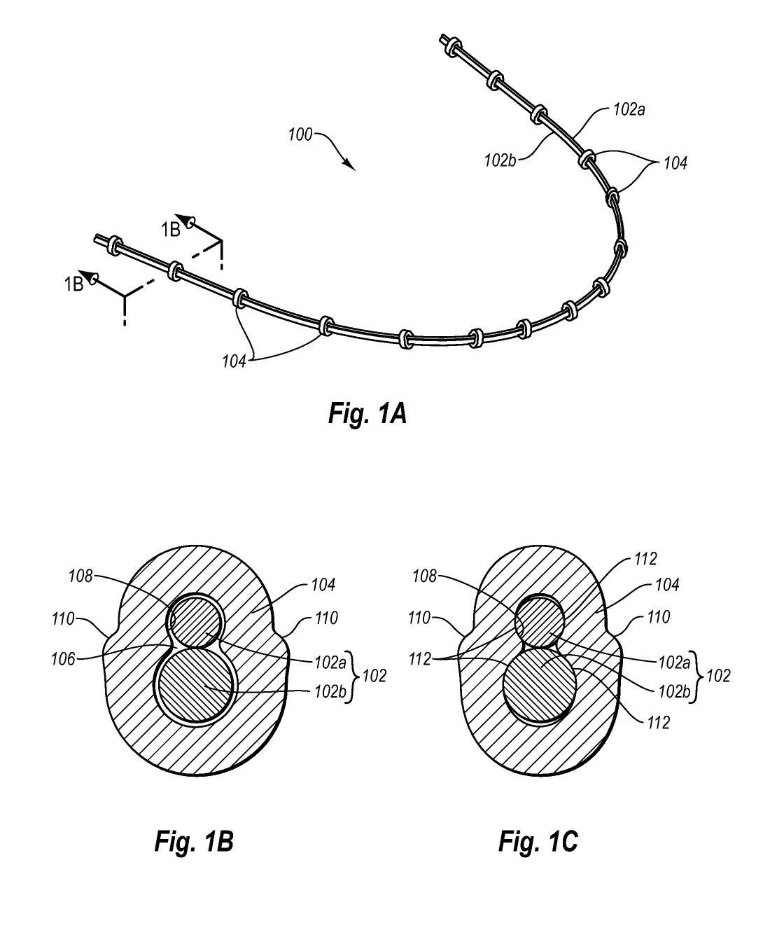

FIGS. 1A-1C illustrate an exemplary dual cylindrical arch wire assembly 100 including a first arch wire body 102a and a second arch wire body 102b. Together, bodies 102a and 102b comprise arch wire 102. Dual cylindrical arch wire assembly 100 also includes a plurality of crimpable clamps 104. Each clamp 104 is initially slidable along arch wire 102 and encloses around the perimeter of arch wire 102.

As illustrated in FIGS. 1B-1C, each of arch wire bodies 102a and 102b may be of different diameters. Alternatively, they may be of the same diameter. Exemplary diameters range from about 0.01 inch to about 0.02 inch. Typical wire diameters include, but are not limited to 0.012, 0.014, 0.016 and 0.017 inch. For example, the embodiment illustrated in FIGS. 1B-1C may include a first arch wire body 102a having a diameter of about 0.012 inch, while the second arch wire body 102b has a diameter of about 0.016 inch. Such embodiments including one larger and one smaller diameter wire may be particularly beneficial as they exhibit a stiffness and moment of inertia that is significantly less than a similarly sized rectangular wire. The moment of inertia of the arch wire's cross-sectional area measures the wire's ability to resist bending. The larger the moment of inertia, the less the wire will bend (i.e., it will be stiffer). For example, an embodiment including a first arch wire body having a diameter of about 0.012 inch and a second arch wire body having a diameter of about 0.016 inch will exhibit less stiffness and a lower moment of inertia than a embodiment including two arch wire bodies having diameters of about 0.016 inch. Both will exhibit lower stiffness and moment of inertia than a rectangular arch wire measuring about 0.032 inch in one dimension and about 0.016 inch in the other dimension.

The arch wires may be used with any suitably sized bracket slot, including, but not limited to typical slots measuring either about 0.018 inch or about 0.022 inch in the occlusal-gingival direction and about 0.028 inch to about 0.030 inch in the labial-lingual direction. Although these slot sizes are typical, the inventive arch wires may alternatively be used with other sized slots.

As seen in FIG. 1B, clamp 104 encloses the full perimeter of arch wire 102. Initially, a space 106 may exist between an inside surface 108 of clamp 104 and the outer surface of first and second arch wire bodies 102a and 102b. In this initial configuration, clamp 104 is advantageously slidable along arch wire 102. The outer surface of clamp 104 further includes a pair of oppositely located ledges 110, which facilitate pinching of clamp 104 between pliers or another suitable clamping tool without slippage. As illustrated in FIG. 1C, once the practitioner crimps down on clamp 104 (e.g., with pliers at or utilizing ledges 110), the clamp 104 is no longer freely slidable along arch wire 102. Rather, arch wire bodies 102a and 102b are frictionally engaged by interior surface 108 of clamp 104 (e.g., at locations 112).

In addition, once clamp 104 has been crimped down as in FIG. 1C, first arch wire body 102a and second arch wire body 102b act as a single arch wire having an approximate FIG. 8 cross-section as illustrated. In other words, first arch wire body 102a cannot be rotated about its longitudinal axis while arch wire body 102b remains stationary or rotates at a different rate or direction. If one of bodies 102a or 102b is rotated, they both rotate together so as to act as a single arch wire. In this way, the arch wire 102 is advantageously able to apply a torquing force against a slot of an orthodontic bracket.

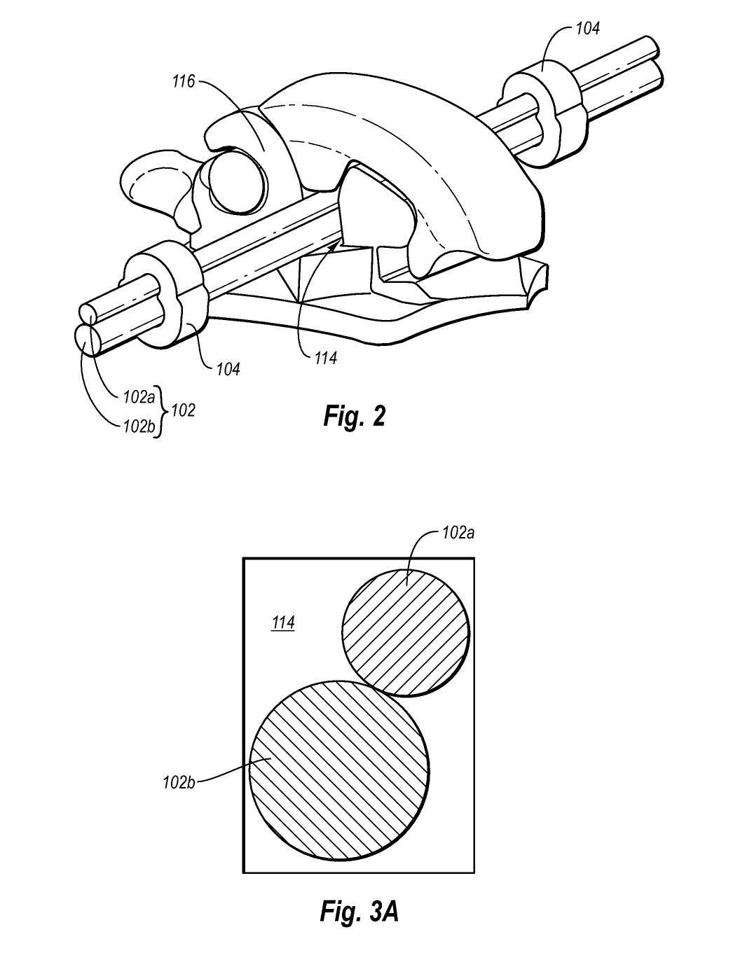

FIG. 2 illustrates the arch wire 102 including first arch wire body 102a and second arch wire body 102b inserted within a slot 114 of an orthodontic bracket 116. Because first and second arch wire bodies 102a and 102b act as a single arch wire having a non-round cross-section, it is possible for the arch wire 102 to apply a torquing force against slot 114 of bracket 116, which in turn is transferred to a tooth to effect torquing movement of a desired tooth.

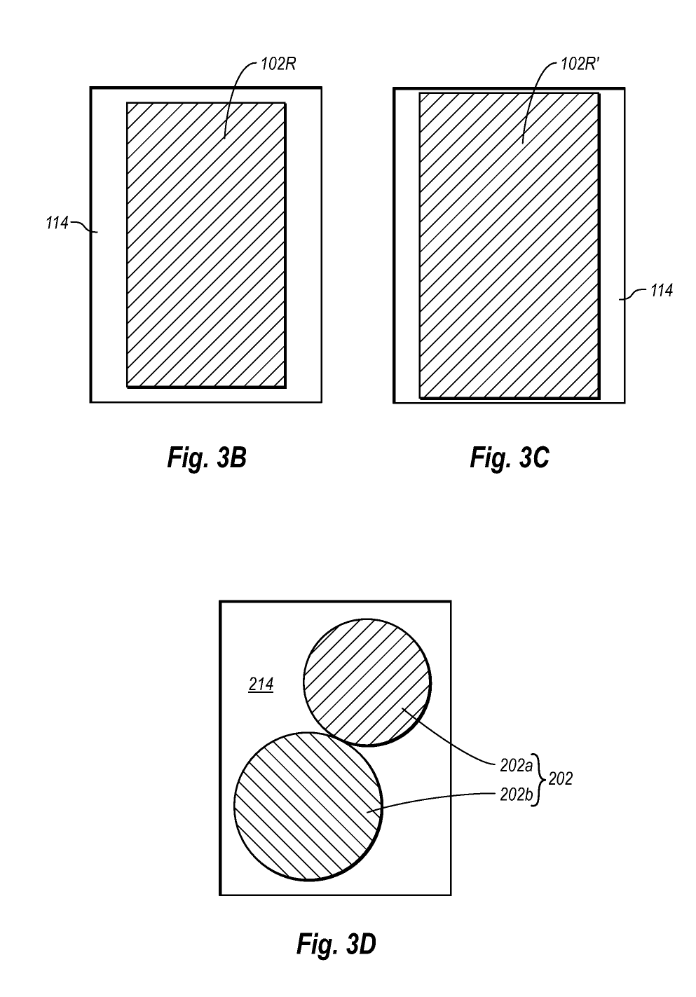

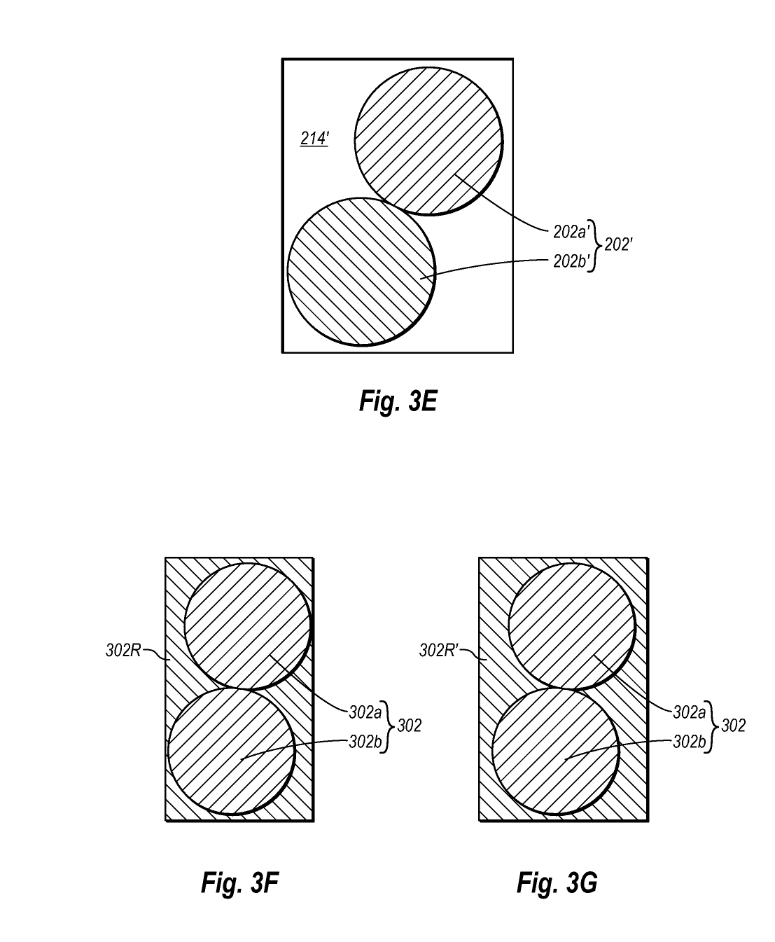

FIGS. 3A-3G illustrate transverse cross-sections of various arch wire alternative embodiments. FIG. 3A illustrates a cross-sectional view of an arch wire 102 including a first arch wire body 102a having a diameter of about 0.012 inch, and a second arch wire body 102b having a diameter of about 0.017 inch within a slot 114 of an orthodontic bracket. Slot 114 has dimensions of about 0.022 by 0.030 inch. It will be noted that the cross-sectional area occupied by arch wire 102 is much less than the overall cross-sectional area occupied by a typical rectangular arch wire within the same size slot (FIGS. 3B and 3C). FIG. 3B illustrates a rectangular arch wire 102R having dimensions of about 0.015 by 0.027 inch, while FIG. 3C illustrates the same size rectangular slot 114 with a rectangular arch wire 102R′ having dimensions of about 0.017 by 0.029 inch. The cross-sectional area of the embodiment of FIG. 3A is about 16% less than that of FIG. 3B, and about 31% less than that of FIG. 3C. This significant reduction in cross-sectional area, together with the accompanying reduction in stiffness and moment of inertia, results in a relatively lighter force treatment, and which can advantageously provide torquing correction to selected teeth.

In a preferred embodiment, the dual cylindrical arch wire bodies have a transverse cross-sectional area that is at least about 15% less than a cross-sectional area of a rectangular arch wire having a width and length equal to the maximum width and maximum length of the first and second cylindrical arch wire bodies. Preferably, the cross-sectional area is at least about 20% less, and more preferably at least about 25% less, than a cross-sectional area of a rectangular arch wire having a width and length equal to the maximum width and maximum length of the first and second cylindrical arch wire bodies.

The inventive arch wire assembly may include first and second arch wire bodies of the same or different diameters, and the inventive arch wires may be used within bracket slots of various sizes. FIG. 3D illustrates an alternative arch wire 202 including a first arch wire body 202a having a diameter of about 0.012 inch and a second arch wire body 202b having a diameter of about 0.014 inch within an arch wire slot 214 having dimensions of about 0.022 by about 0.028 inch. Arch wire 202 has a cross-sectional area that is about 27% less than a rectangular arch wire having dimensions of about 0.014 by 0.026 inch, 34% less than the rectangular arch wire of FIG. 3B, and about 42% less than the rectangular arch wire of FIG. 3C.

FIG. 3E illustrates an arch wire 202′ including a first arch wire body 202a′ and a second arch wire body 202b′ in which both arch wire bodies have the same diameter (e.g., about 0.014 inch). Arch wire 202′ is illustrated within slot 214′ having dimensions of about 0.022 by about 0.028 inch. Arch wire 202′ has a cross-sectional area that is about 21% less than a rectangular arch wire having dimensions of about 0.014 by 0.028 inch.

FIGS. 3F and 3G illustrate an arch wire 302 including first and second arch wire bodies 302a and 302b having equal diameters (e.g., about 0.012 inch). In FIG. 3F, the arch wire 302 is superimposed over an arch wire 302R having a rectangular cross-section having dimensions of about 0.014 by about 0.025 inch, and in FIG. 3G, the arch wire 302 is superimposed over an arch wire 302R′ having a rectangular cross-section having dimensions of about 0.016 by about 0.025 inch. Arch wire 302 has a cross-sectional area that is about 35% less than the typical rectangular arch wire 302R (FIG. 3F), about 43% less than the typical rectangular arch wire 302R′ (FIG. 3G), and about 22% less than a rectangular arch wire having equal maximum width and length dimensions of about 0.012 by 0.024 inch.

### III. Exemplary Methods of Use

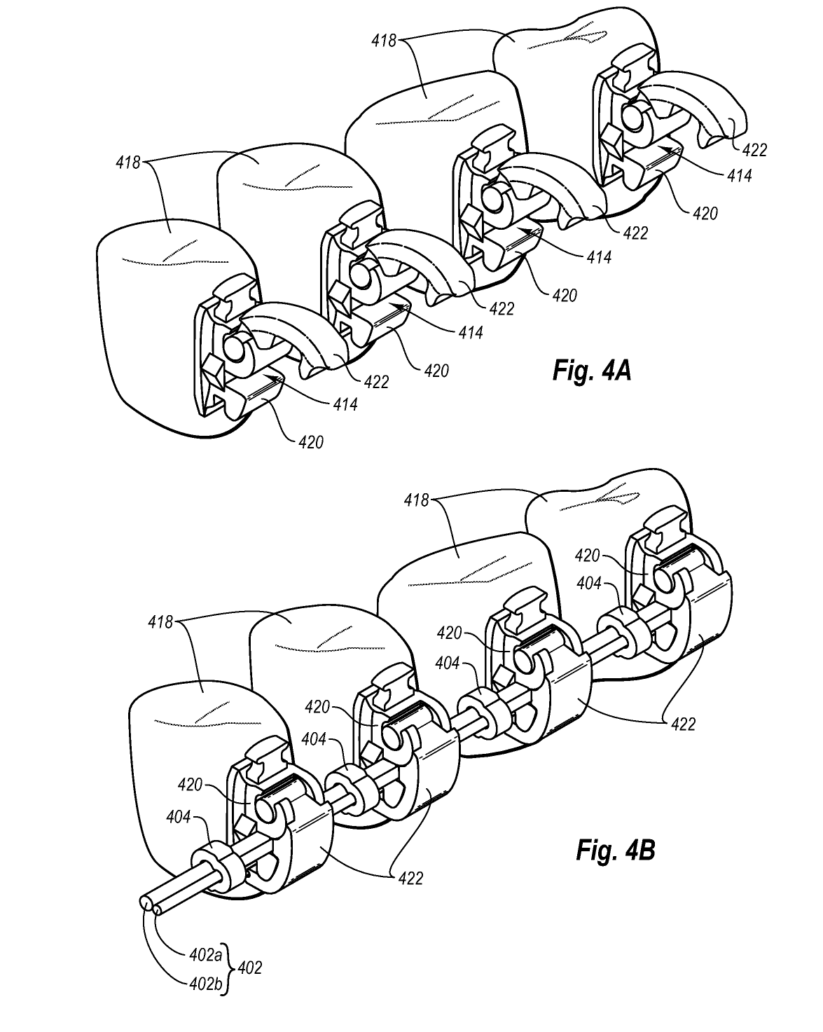

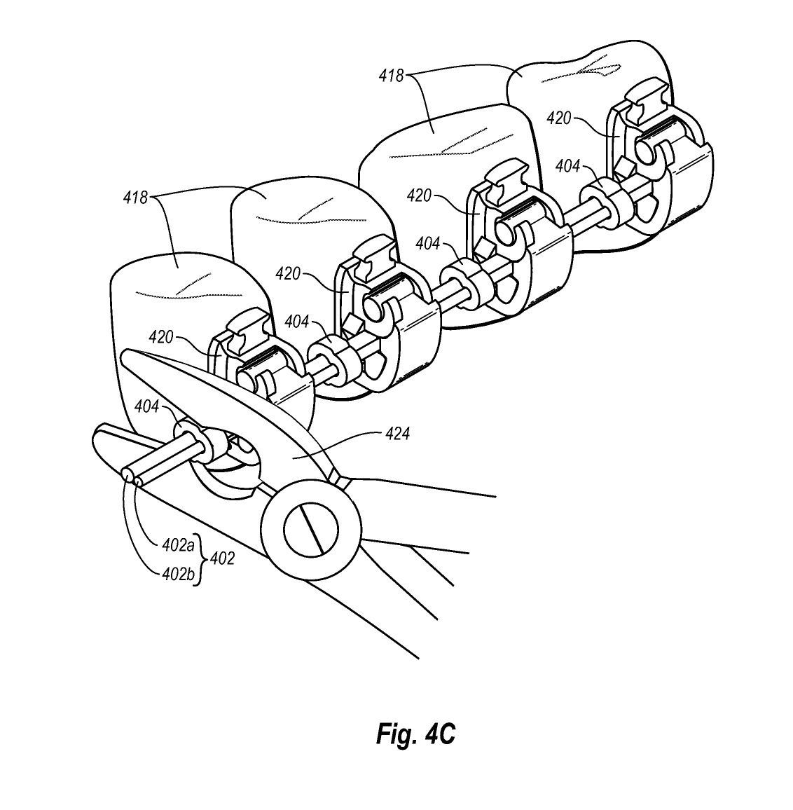

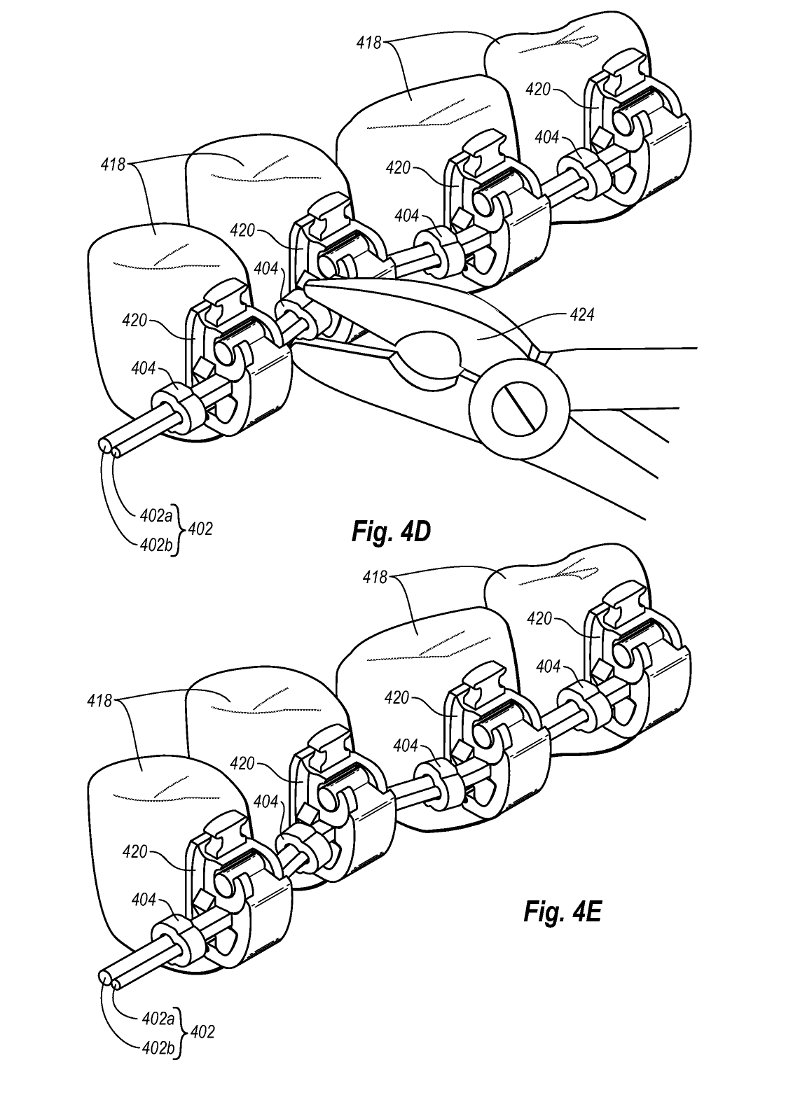

FIGS. 4A-4E illustrate an exemplary method of using the inventive dual cylindrical torquing arch wire assembly. FIG. 4A shows a plurality of teeth 418 to which orthodontic brackets 420 have been bonded. As illustrated, the ligation covers 422 are initially in an open position, so that the slots 414 of brackets 420 are accessible. The illustrated self-ligating brackets 420 are advantageously configured such that when the ligation cover 422 is fully open, the slot is completely unoccluded, so as to be easily accessible to the practitioner. Although illustrated with self-ligating orthodontic brackets, it is to be understood that any type of orthodontic brackets or combination of brackets (e.g., non self-ligating and/or self-ligating) may be used with the inventive dual cylindrical torquing arch wire assembly.

As shown in FIG. 4B, the practitioner inserts the dual cylindrical arch wire 402 into each open slot of each bracket 420, and then closes the ligation covers 422 so as to retain the arch wire bodies 402a and 402b within slots 414. Either prior to or subsequent to inserting the arch wire 402 into slots 414, the practitioner crimps down on each crimpable clamp 404, as shown in FIG. 4C. A pair of pliers 424 or other suitable crimping tool may be used.

In one embodiment, and as illustrated, a clamp 404 may be positioned between each pair of orthodontic brackets so as to fix the arch wire bodies relative to one another at regular intervals.

If desired, a bend may be applied to arch wire 402 prior to crimping a clamp, as shown in FIG. 4D. The clamp 404 helps the arch wire 402 to retain the bend, even where arch wire 402 is formed of a super-elastic material (e.g., a super-elastic nickel titanium alloy), as the arch wire bodies are clamped at each end of the bend.

Once all clamps 404 have been crimped down on arch wire 402 (FIG. 4E), the arch wire bodies 402a and 402b are fixed together so as to act as a single arch wire, rather than two separate cylindrical arch wires. In other words, arch wire 402 acts as a single arch wire having an approximate FIG. 8 cross-section, rather than as two independent arch wires, with each having a circular cross-section. In this way, the inventive dual cylindrical arch wire is able to provide a torquing force against the slot of the orthodontic bracket, which is transferred to the tooth so as to effect the necessary torquing correctional movement. Although illustrated with crimpable clamps 404, it is to be understood that in an alternative embodiment the arch wire bodies 402a and 402b may be glued, welded, or otherwise fused together (e.g., during manufacture). Furthermore, any optional bends in arch wire 402 may be applied prior to inserting the arch wire into the bracket slots and closing ligation covers 422, depending on the preference of the practitioner.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A dual arch wire assembly for applying torquing corrective forces against an arch wire slot, comprising:
an arch wire comprising first and second cylindrical arch wire bodies extending between first and second ends, the first and second cylindrical arch wire bodies being disposed in adjacent contact one with another; and
means for fixing the first and second arch wire bodies relative to each other so as to allow the first and second cylindrical arch wire bodies to exert a torquing corrective force against an arch wire slot of an orthodontic bracket during an orthodontic treatment.

2. A dual arch wire assembly as recited in claim 1, wherein the means for selectively fixing the first and second arch wire bodies comprises the first and second arch wire bodies being fused together.

3. A dual arch wire assembly as recited in claim 1, wherein the means for selectively clamping the first and second arch wire bodies comprises a plurality of crimpable clamps that are configured to enclose around a perimeter of the first and second arch wire bodies, the clamps being initially slidable along a length of the first and second arch wires so as to each be crimpable at a selected location, the clamps being configured to clamp the arch wire bodies together so as to prevent rotation of the first arch wire body about a longitudinal axis of the first arch wire body relative to the second arch wire body.

4. A dual arch wire assembly as recited in claim 1, wherein the first and second cylindrical arch wire bodies are initially movable relative to one another.

5. A dual arch wire assembly as recited in claim 1, wherein the first and second arch wire bodies have a transverse cross-sectional area that is less than a cross-sectional area of a rectangular arch wire having a width and length equal to a maximum width and maximum length of the first and second cylindrical arch wire bodies.

6. A dual arch wire assembly as recited in claim 5, wherein the first and second arch wire bodies have a transverse cross-sectional area that is at least about 15% less than a cross-sectional area of a rectangular arch wire having a width and length equal to a maximum width and maximum length of the first and second cylindrical arch wire bodies.

7. A dual arch wire assembly as recited in claim 5, wherein the first and second arch wire bodies have a transverse cross-sectional area that is at about least 20% less than a cross-sectional area of a rectangular arch wire having a width and length equal to a maximum width and maximum length of the first and second cylindrical arch wire bodies.

8. A dual arch wire assembly as recited in claim 5, wherein the first and second arch wire bodies have a transverse cross-sectional area that is at least about 25% less than a cross-sectional area of a rectangular arch wire having a width and length equal to a maximum width and maximum length of the first and second cylindrical arch wire bodies.

9. A dual arch wire assembly as recited in claim 1, wherein the arch wire comprising first and second cylindrical arch wire bodies has a transverse cross-sectional configuration that is shaped as an approximate FIG. 8.

10. A dual arch wire assembly as recited in claim 1, wherein the first and second arch wire bodies comprise a super-elastic material.

11. A dual arch wire assembly as recited in claim 1, wherein the first and second arch wire bodies comprise a nickel-titanium alloy.

12. A dual arch wire assembly as recited in claim 1, wherein the first arch wire body has a diameter that is smaller than a diameter of the second arch wire body.

13. A dual arch wire assembly as recited in claim 1, wherein the first arch wire body has a diameter that is substantially the same as a diameter of the second arch wire body.

14. A dual arch wire assembly as recited in claim 1, wherein the arch wire consists of the first and second cylindrical arch wire bodies.

15. A dual arch wire assembly as recited in claim 1, wherein the first and second arch wire bodies have diameters ranging from about 0.01 inch to about 0.02 inch.

16. A dual arch wire assembly for applying torquing corrective forces against an arch wire slot, comprising:
an arch wire comprising first and second cylindrical arch wire bodies extending between first and second ends, the first and second cylindrical arch wire bodies being disposed in adjacent contact with one another; and
a plurality of crimpable clamps configured to enclose around a perimeter of the first and second arch wire bodies, the clamps being initially slidable along a length of the first and second arch wires so that each is crimpable at a selected location, the clamps being configured to clamp the arch wire bodies together so as to prevent rotation of the first arch wire body about a longitudinal axis of the first arch wire body relative to the second arch wire body.

17. A method of orthodontic treatment using a dual torquing arch wire assembly comprising:
providing first and second cylindrical arch wire bodies extending between first and second ends, the first and second cylindrical arch wire bodies being disposed in adjacent contact with one another;
inserting the first and second cylindrical arch wire bodies into a plurality of arch wire slots of a plurality of orthodontic brackets; and
fixing the first and second arch wire bodies relative to each other so as to allow the first and second cylindrical arch wire bodies to exert a torquing corrective force against an arch wire slot of an orthodontic bracket during an orthodontic treatment.

18. A method as recited in claim 17, further comprising applying a bend to the first and second arch wire bodies such that the first and second arch wire bodies retain the bend.

19. A method as recited in claim 17, wherein the first and second arch wire bodies are fixed by a clamp positioned between each pair of orthodontic brackets.

20. A method as recited in claim 17, wherein the first and second arch wire bodies are fixed relative to each other by fusing during manufacture.

21. A method as recited in claim 17, wherein the first and second arch wire bodies are fixed relative to each other after inserting the first and second cylindrical arch wire bodies into a plurality of arch wire slots of a plurality of orthodontic brackets.
